(19) United States
(12) Patent Application Publication
(10) Pub. No.: US 2018/0018245 A1
(43) Pub. Date: Jan. 18, 2018

(54) STORAGE SYSTEM AND MANAGEMENT APPARATUS

(71) Applicant: FUJITSU LIMITED, Kawasaki-shi (JP)

(72) Inventors: Yuzo Kori, Kawasaki (JP); Katsuya Niigata, Kawasaki (JP)

(73) Assignee: FUJITSU LIMITED, Kawasaki-shi (JP)

(21) Appl. No.: 15/642,387

(22) Filed: Jul. 6, 2017

(30) Foreign Application Priority Data
Jul. 15, 2016 (JP) 2016-140192

(51) Int. Cl. G06F 11/20; G06F 3/06

(52) U.S. Cl. CPC G06F 11/2069; G06F 11/2089; G06F 3/0619; G06F 3/065; G06F 3/0685

(57) ABSTRACT

In a storage system, when there is a power failure for a power supply, a control unit of a master apparatus does not have all of the dirty data stored in the cache regions of a plurality of storage control apparatuses stored into their nonvolatile memories and instead has part of the dirty data stored from mirror cache regions of adjacent storage control apparatuses into their nonvolatile memories. When doing so, the ratio between the amount of data stored from a cache region and the amount of data stored from a mirror cache region is decided so that the differences in the amount of data stored in the respective nonvolatile memories are within a predetermined range.

### CROSS-REFERENCE TO RELATED APPLICATION

This application is based upon and claims the benefit of priority of the prior Japanese Patent Application No. 2016-140192, filed on Jul. 15, 2016, the entire contents of which are incorporated herein by reference.

### FIELD

The present embodiments discussed herein are related to a storage system and a management apparatus.

### BACKGROUND

A storage control apparatus typically uses a cache when controlling access to a storage apparatus in response to a request from a host apparatus. When a write-back technique is used to control writes using a cache, it is preferable to take measures to prevent data loss of so-called “dirty data”, i.e., data in the cache that has not been stored in a storage apparatus, which occurs when the storage control apparatus stops unexpectedly.

In a storage system equipped with a plurality of storage control apparatuses, it is possible for example to prevent loss of the dirty data described above by duplicating the data in the cache of a storage control apparatus in the memory of another storage control apparatus. As one example of this type of storage system, a system has been proposed where each storage control apparatus is provided with a local cache and a mirror cache and the local cache of one storage control apparatus is duplicated in the mirror cache of an adjacent storage control apparatus so that each cache is cyclically duplicated.

Another proposed technology relating to the protection of dirty data is the storage system described below which has a plurality of control modules. In this storage system, at least one dirty data element stored in a first cache memory in a first control module is copied into a second cache memory in a second control module. At least one dirty data element stored in the second cache memory is also backed up in a nonvolatile storage resource.

See, for example, International Publication Pamphlet No. WO2004/114115 and Japanese Laid-open Patent Publication No. 2009-048544.

Among storage systems where caches are cyclically backed up as described above, in some cases a battery is provided to supply power for backing up the dirty data in a cache into a nonvolatile storage apparatus when a power failure occurs. Hereinafter, it is assumed that a battery is provided in this way in each storage control apparatus.

The amount of dirty data in a cache will differ between storage control apparatuses. This means that when a power failure occurs, the time taken for all of the dirty data in a cache to be backed up will differ between the storage control apparatuses. Since the drop in the battery level will also depend on the time taken by backing up, the battery level remaining when the backing up of dirty data is completed will also differ between the storage control apparatuses.

When the supplying of power is recommenced, the respective storage control apparatuses write the data that was backed-up into a nonvolatile storage apparatus back into a back-end storage apparatus or a back into a cache. In addition, when their batteries have been fully recharged, the respective storage control apparatuses recommence an access control process to a storage apparatus performed using a cache. This arrangement is used so that it is possible to back up dirty data in the cache once again after the access control process is recommenced.

Here, as described above, when the battery level remaining when the backing up of dirty data is complete differs between the storage control apparatuses, the time taken for the battery to become fully recharged after the restoration of power will also differ between the storage control apparatuses. This means that the time taken until all of the storage control apparatuses restart the access control process after the restoration of power will be the time taken to fully recharge the battery that had the lowest remaining level when the backing up of dirty data was complete.

In other words, the backing-up time taken by the storage control apparatus with the largest amount of dirty data will determine the backing-up time taken by the system as a whole. This backing-up time also influences the time taken for the system as a whole to recommence the access control process after the restoration of power. Accordingly, there is the problem that when there is a storage control apparatus that has a large amount of dirty data and will take a long time to perform the backup process when there is a power failure, the time taken for the system as a whole to recommence the access control process after the restoration of power becomes longer.

### SUMMARY

According to one aspect, there is provided a storage system including: a power supply; and a plurality of storage control apparatuses that are placed in a cyclic arrangement and operate on power supplied from the power supply, wherein the plurality of storage control apparatuses each include: a volatile memory including a cache region and a mirror cache region; a nonvolatile memory; a processor that mirrors data stored in the cache region to the mirror cache region of another storage control apparatus that is adjacent in a predetermined direction in the cyclic arrangement of the plurality of storage control apparatuses; and a battery that supplies power for storing data from the volatile memory into the nonvolatile memory when there is a power failure for the power supply, wherein the processor of a master apparatus decided in advance out of the plurality of storage control apparatuses: classifies, at each of the plurality of storage control apparatuses when there is a power failure for the power supply, dirty data stored in the cache region into first data and second data, and designates the first data stored in the cache region as first backup data and mirror data of the second data, which is stored in the mirror cache region of the other storage control apparatus adjacent in the predetermined direction, as second backup data, wherein classification of the dirty data includes deciding a ratio of data amounts of the first data and the second data for each of the plurality of storage control apparatuses so that differences between the storage control apparatuses in a total amount of the first backup data designated in the cache region and the second backup data designated in the mirror cache region are within a predetermined range; and controls the plurality of storage control apparatuses so that each of the plurality of storage control apparatuses stores the first backup data and the second backup data in the nonvolatile memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an example configuration and example processing of a storage system according to a first embodiment;

FIG. 2 depicts an example configuration of a storage system according to a second embodiment;

FIG. 3 depicts the hardware configuration of a controller module;

FIG. 4 depicts the relationship between cache regions and mirror caches where the cache regions are mirrored;

FIG. 5 depicts an example of size ratios of the dirty data stored in the cache regions;

FIG. 6 depicts example transitions in the battery level during a power failure and when power is restored;

FIG. 7 depicts an example configuration of the processing functions provided in a controller module;

FIG. 8 depicts an example setting of how data is backed up when a first equalization method is used;

FIG. 9 depicts example transitions in a battery level during a power failure and during restoration of power;

FIG. 10 depicts a method of calculating the amount of data to be backed up in each cache region;

FIG. 11 depicts an example setting of how data is backed up when a second equalization method is used;

FIG. 12 depicts example transitions in the battery level during a power failure and when power is restored;

FIG. 13 depicts an example configuration of data to be stored in backup memories;

FIG. 14 is a first part of a flowchart depicting an example procedure of backup processing by a master controller module;

FIG. 15 is a second part of a flowchart depicting the example procedure of the backup processing by the master controller module;

FIG. 16 is a first part of a flowchart depicting an example procedure of a recovery process of a controller module when power is restored; and

FIG. 17 is a second part of the flowchart depicting an example procedure of the recovery process of the controller module when power is restored.

### DESCRIPTION OF EMBODIMENTS

Several embodiments will be described below with reference to the accompanying drawings, wherein like reference numerals refer to like elements throughout.

### First Embodiment

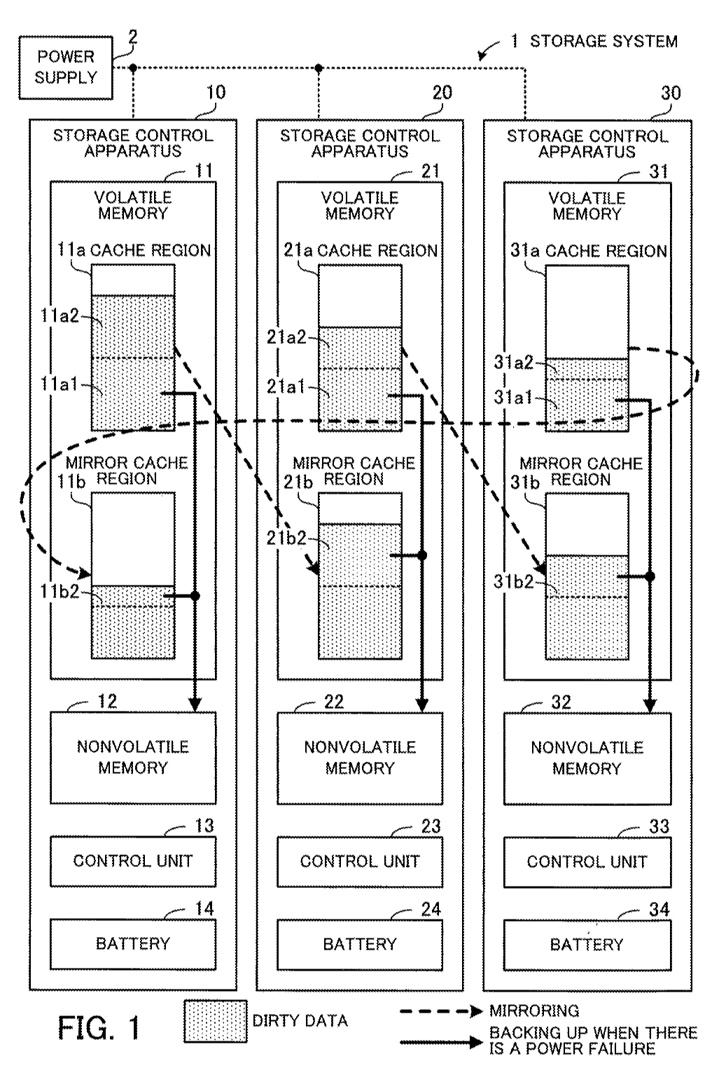

FIG. 1 depicts an example configuration and example processing of a storage system according to a first embodiment. The storage system 1 depicted in FIG. 1 includes a power supply 2 and storage control apparatuses 10, 20, and 30 that operate on power supplied from the power supply 2. The storage control apparatuses 10, 20, and 30 are placed in a cyclic arrangement. In the example in FIG. 1, the apparatuses are arranged in the order “storage control apparatus 10, storage control apparatus 20, storage control apparatus 30, storage control apparatus 10, . . . .” Note that the number of storage control apparatuses may be any number that is two or higher.

The storage control apparatus 10 is a control apparatus that controls access to a storage apparatus, not depicted. In the same way, the storage control apparatus is a control apparatus that controls access to a storage apparatus, not depicted, and the storage control apparatus 30 is a control apparatus that controls access to a storage apparatus, not depicted. The storage apparatuses subject to access control by the storage control apparatuses 10, 20, and 30 may be the same storage apparatus or may be different storage apparatuses.

The storage control apparatus 10 includes a volatile memory 11, a nonvolatile memory 12, a control unit 13, and a battery 14. The storage control apparatus 20 includes a volatile memory 21, a nonvolatile memory 22, a control unit 23, and a battery 24. The storage control apparatus 30 includes a volatile memory 31, a nonvolatile memory 32, a control unit 33, and a battery 34. Since the storage control apparatuses 10, 20, and 30 have the same configuration, the configuration of the storage control apparatus 10 will be described here as a representative example.

The volatile memory 11 is realized by DRAM (Dynamic Random Access Memory), for example. The volatile memory 11 includes a cache region 11a and a mirror cache region 11b. The cache region 11a is used as a cache when the storage control apparatus 10 controls access to a storage apparatus. Data in the cache region provided in another storage control apparatus (in the example in FIG. 1, the cache region 31a of the storage control apparatus 30) is mirrored in the mirror cache region 11b.

The nonvolatile memory 12 is realized by flash memory, for example. The nonvolatile memory 12 is used as a backup region for data when there is a power failure at the power supply 2.

The control unit 13 is realized by a processor, for example. The control unit 13 mirrors the data in the cache region 11a in a mirror cache region of another storage control apparatus that is adjacent in a predetermined direction in the arrangement of the storage control apparatuses 10, 20, and 30. In the example in FIG. 1, mirroring is performed into the mirror cache region 21b of the storage control apparatus 20.

The battery 14 supplies power for storing data from the volatile memory 11 into the nonvolatile memory 12 when there is a power failure for the power supply 2.

Here, in the storage system 1, the cache region of a storage control apparatus is mirrored in a mirror cache region of another storage control apparatus that is adjacent in a predetermined direction in the arrangement described above. More specifically, the data in the cache region 11a of the storage control apparatus 10 is mirrored in the mirror cache region 21b of the storage control apparatus 20. The data in the cache region 21a of the storage control apparatus 20 is mirrored in the mirror cache region 31b of the storage control apparatus 30. The data in the cache region 31a of the storage control apparatus 30 is mirrored in the mirror cache region 11b of the storage control apparatus 10.

By mirroring data in this way, even when there is a failure at one out of two storage control apparatuses that are adjacent in the arrangement described above, data will remain without being deleted in one of the cache region and the corresponding mirror cache. The other storage control apparatus is therefore able to continue to perform access control to the storage apparatus using this remaining data.

One of the storage control apparatuses 10, 20, and 30 is set so as to operate as a master apparatus when there is a power failure. The following description assumes that the storage control apparatus 10 is the master apparatus. When there is a power failure for the power supply 2, the control unit 13 of the storage control apparatus 10 executes the following processing to back up the dirty data in the cache regions.

The control unit 13 classifies the dirty data stored in the respective cache regions of the storage control apparatuses 10, 20, and 30 into first data and second data. As one example, the dirty data stored in the cache region 11a is classified into first data 11a1 and second data 11a2. The dirty data stored in the cache region 21a is classified into first data 21a1 and second data 21a2 and the dirty data stored in the cache region 31a is classified into first data 31a1 and second data 31a2.

The control unit 13 designates, at each of the storage control apparatuses 10, 20, and 30, the first data stored in the cache region as “first backup data” and designates mirror data of the second data, which is stored in the mirror cache region of another storage control apparatus that is adjacent in the predetermined direction in the arrangement described above, as “second backup data”.

More specifically, the first data 11a1 stored in the cache region 11a of the storage control apparatus 10 is designated as first backup data. Together with this, the mirror data 21b2 which corresponds to the second data 11a2 and is stored in the mirror cache region 21b of the adjacent storage control apparatus 20 is designated in place of the second data 11a2 as second backup data.

In the same way, the first data 21a1 stored in the cache region 21a of the storage control apparatus 20 is designated as first backup data. Together with this, the mirror data 31b2 which corresponds to the second data 21a2 and is stored in the mirror cache region 31b of the adjacent storage control apparatus 30 is designated in place of the second data 21a2 as second backup data.

In the same way, the first data 31a1 stored in the cache region 31a of the storage control apparatus 30 is designated as first backup data. Together with this, the mirror data 11b2 which corresponds to the second data 31a2 and is stored in the mirror cache region 11b of the adjacent storage control apparatus 10 is designated in place of the second data 31a2 as second backup data.

Here, in the classification process for the first data and second data the ratio between the first data and the second data at each storage control apparatus is decided as follows. The control unit 13 decides the ratio between the first data and the second data separately at each storage control apparatus so that differences between the storage control apparatuses 10, 20, and 30 in a total amount produced by adding the first backup data designated in the cache region and the second backup data designated in the mirror cache region are within a predetermined range.

More specifically, a first total data amount of the first data 11a1 designated as the first backup data and the mirror data 11b2 designated as the second backup data is calculated for the storage control apparatus 10. A second total data amount of the first data 21a1 designated as the first backup data and the mirror data 21b2 designated as the second backup data is calculated for the storage control apparatus 20. A third total data amount of the first data 31a1 designated as the first backup data and the mirror data 31b2 designated as the second backup data is calculated for the storage control apparatus 30. The ratios are then decided so that the highest value out of the differences between the first total data amount, the second total data amount, and the third total data amount is within a predetermined range. The ratios referred to here are the ratio between the first data 11a1 and the second data 11a2 at the storage control apparatus 10, the ratio between the first data 21a1 and the second data 21a2 at the storage control apparatus 20, and the ratio between the first data 31a1 and the second data 31a2 at the storage control apparatus 30.

After this, the control unit 13 carries out control so that at each of the storage control apparatuses 10, 20, and 30, the first backup data and the second backup data are stored in the nonvolatile memory. Due to this control, at the storage control apparatus 10, the first data 11a1 designated as the first backup data and the mirror data 11b2 designated as the second backup data are stored in the nonvolatile memory 12. At the storage control apparatus 20, the first data 21a1 designated as the first backup data and the mirror data 21b2 designated as the second backup data are stored in the nonvolatile memory 22. At the storage control apparatus 30, the first data 31a1 designated as the first backup data and the mirror data 31b2 designated as the second backup data are stored in the nonvolatile memory 32.

By calculating the ratios as described above, the amounts of data stored in the nonvolatile memories 12, 22, and 32 become substantially equal. This means that the largest amount of data to be stored in a nonvolatile memory is suppressed compared to a case where the dirty data stored in the cache regions 11a, 21a, and 31a is stored in the nonvolatile memories 12, 22, and 32, respectively. In the example in FIG. 1, out of the cache regions 11a, 21a, and 31a, the largest amount of dirty data is stored in the cache region 11a. In this case, the largest amount of data to be stored in a nonvolatile memory when the storing process is performed according to the control by the control unit 13 described above is smaller than the amount of data when all of the data in the cache region 11a is stored in the nonvolatile memory 12.

The amount of data to be stored in a nonvolatile memory is in a proportional relationship with the storing time and is also in a proportional relationship with the discharging time of a battery. When the dirty data stored in the cache region 11a, 21a, and 31a is stored in the nonvolatile memory 12, 22, and 32, the battery 14 of the storage control apparatus 10 is discharged by the greatest amount. However, performing the storing process according to the control by the control unit 13 described above suppresses discharging of the battery 14 of the storage control apparatus 10 compared to when all of the dirty data in the cache region 11a is saved in the nonvolatile memory 12.

That is, the control performed by the control unit 13 when there is a power failure increases the probability of a reduction in the largest amount of discharging of the batteries 14, 24, and 34. As a result, it is possible to raise the probability of a reduction in the time taken from when the supplying of power from the power supply 2 recommences and the recharging of the batteries 14, 24, and 34 starts until the recharging of all of the batteries is completed. By reducing the time taken until recharging of all of the batteries 14, 24, and 34 is completed, the time taken until all of the storage control apparatuses 10, 20, and 30 recommence access control to the storage apparatus according to a write-back technique is reduced.

### Second Embodiment

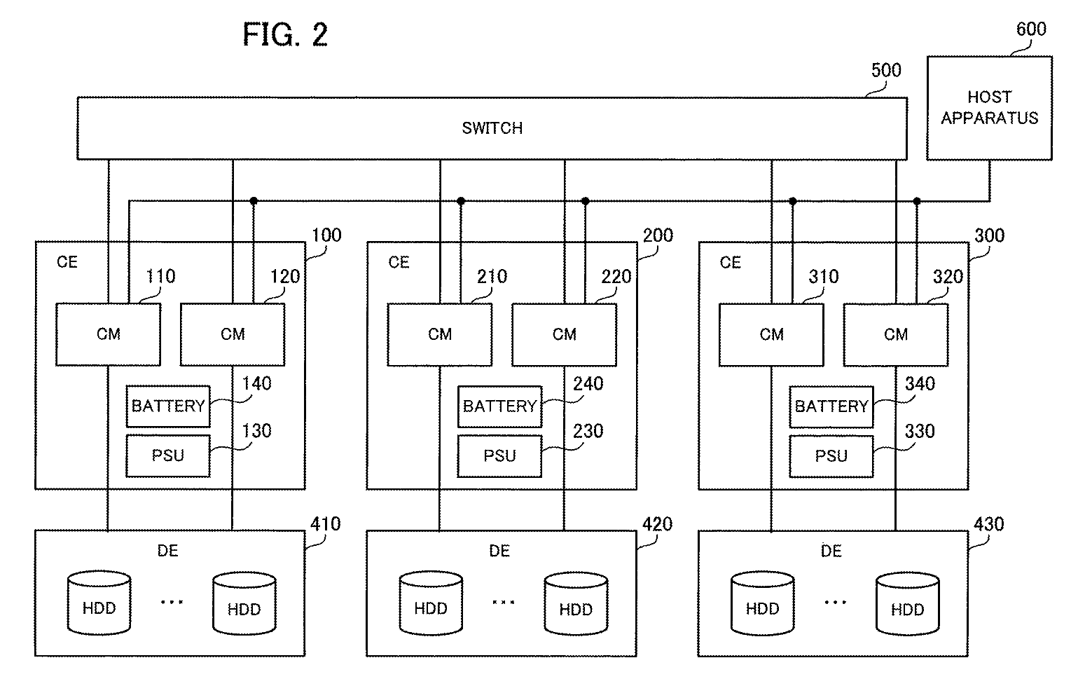

FIG. 2 depicts an example configuration of a storage system according to a second embodiment. The storage system includes controller enclosures (“CE” in the drawings) 100, 200, and 300, device enclosures (“DE” in the drawings) 410, 420, and 430, a switch 500, and a host apparatus 600. Note that the controller enclosures 100, 200, and 300 are examples of the storage control apparatuses 10, 20, and 30 depicted in FIG. 1.

The controller enclosure 100 includes controller modules (“CM” in the drawings) 110 and 120, a power supply unit (“PSU” in the drawings) 130, and a battery 140. The controller enclosure 200 includes controller modules 210 and 220, a power supply unit 230, and a battery 240. The controller enclosure 300 includes controller modules 310 and 320, a power supply unit 330, and a battery 340.

The controller modules 110, 120, 210, 220, 310, and 320 are connected to a host apparatus 600. As examples the controller modules 110, 120, 210, 220, 310, and 320 are connected to the host apparatus 600 via a SAN (Storage Area Network) using a fiber channel or iSCSI (Internet Small Computer System Interface). Note that although one host apparatus 600 is connected to the controller modules 110, 120, 210, 220, 310, and 320 in the example in FIG. 2, each of a plurality of host apparatuses may be connected to one or more controller modules, for example.

A plurality of storage apparatuses that are accessed from the host apparatus 600 are mounted in each of the device enclosures 410, 420, and 430. As one example in the present embodiment, the device enclosures 410, 420, and 430 are disk array apparatuses equipped with hard disk drives (HDDs) as the storage apparatuses. Note that the storage apparatuses mounted in the device enclosures 410, 420, and 430 may be other types of storage apparatuses, such as solid state drives (SSD).

The controller modules 110 and 120 are connected to the device enclosure 410. The controller modules 110 and 120 each have a memory provided with a cache region and control access to the HDDs mounted in the device enclosure 410 in response to requests from the host apparatus 600 using the cache regions provided in the controller modules 110 and 120. The controller modules 210 and 220 are connected to the device enclosure 420. The controller modules 210 and 220 each have a memory provided with a cache region and control access to the HDDs mounted in the device enclosure 420 in response to requests from the host apparatus 600 using the cache regions provided in the controller modules 210 and 220. The controller modules 310 and 320 are connected to the device enclosure 430. The controller modules 310 and 320 each have a memory provided with a cache region and control access to the HDDs mounted in the device enclosure 430 in response to requests from the host apparatus 600 using the cache regions provided in the controller modules 310 and 320.

Note that the controller enclosure 100 and the device enclosure 410 are realized for example as a storage apparatus that is mounted within a single housing. This also applies to the controller enclosure 200 and the device enclosure 420, and to the controller enclosure 300 and the device enclosure 430. The storage system in FIG. 2 is configured by scaling out this type of storage apparatus.

Also, the number of controller enclosures included in the storage system is not limited to three, and the number of controller modules included in each controller enclosure is not limited to two. As one example, the storage system may include twelve device enclosures that each include two controller modules. The controller modules 110, 120, 210, 220, 310, and 320 may also control access to an HDD in a drive enclosure connected to a different controller module in response to a request from the host apparatus 600.

The power supply unit 130 is supplied with power from outside and supplies power to the various components inside the controller enclosure 100. The battery 140 supplies power to the controller modules 110 and 120 during a power failure where the supplying of power from outside to the power supply unit 130 is cut off. The battery 140 supplies the controller modules 110 and 120 with power for a backup process executed by the controller modules 110 and 120 during a power failure. The “backup process” referred to here stores the dirty data stored in the cache region into a nonvolatile storage region.

The power supply unit 230 is supplied with power from outside and supplies power to the various components inside the controller enclosure 200. The battery 240 supplies the power for a backup process executed by the controller modules 210 and 220 during a power failure. The power supply unit 330 is supplied with power from outside and supplies power to the various components inside the controller enclosure 300. The battery 340 supplies the power for a backup process executed by the controller modules 310 and 320 during a power failure.

Note that the power supply units 130, 230, and 330 are examples of the power supply 2 depicted in FIG. 1.

The switch 500 is connected to the controller modules 110, 120, 210, 220, 310, and 320 and relays signals transferred between the controller modules. The controller modules 110, 120, 210, 220, 310, and 320 are capable of communicating with each other via the switch 500.

The hardware configuration of the controller modules 110, 120, 210, 220, 310, and 320 will now be described with the controller module 110 as an example.

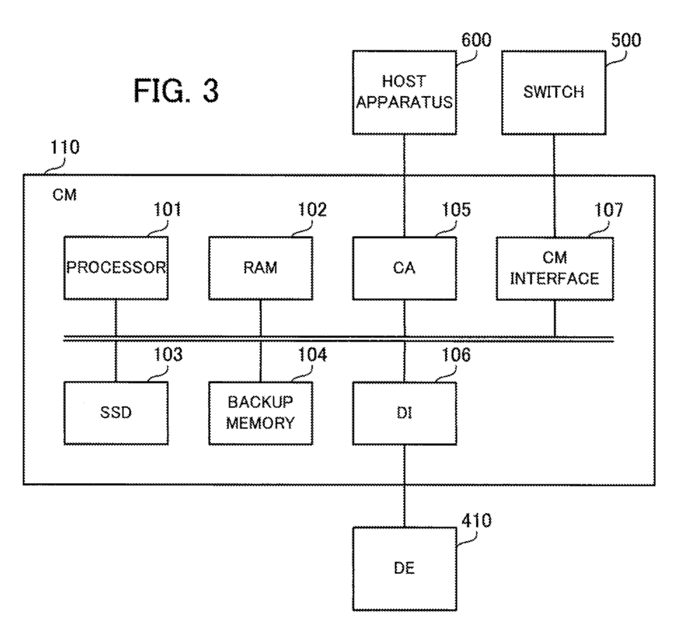

FIG. 3 depicts the hardware configuration of a controller module. The controller module 110 will now be described as an example controller module.

The controller module 110 includes a processor 101, a RAM 102, an SSD 103, a backup memory 104, a channel adapter (“CA” in the drawings) 105, a device interface (“DI” in the drawings) 106, and a controller module interface 107.

The processor 101 controls information processing by the controller module 110. The processor 101 may be a multiprocessor that includes a plurality of processing elements.

The RAM 102 is a main storage apparatus of the controller module 110. The RAM 102 temporarily stores at least part of an OS (Operating System) program and/or an application program to be executed by the processor 101. The RAM 102 stores various data to be used in processing by the processor 101. A cache is also provided in a predetermined region of the RAM 102.

The SSD 103 is an auxiliary storage apparatus of the controller module 110. The SSD 103 is a nonvolatile semiconductor memory. An OS program, application programs, and various data are stored in the SSD 103. Note that the controller module 110 may include an HDD in place of the SSD 103 as an auxiliary storage apparatus.

The backup memory 104 is a nonvolatile semiconductor memory. Part of the data stored in the RAM 102 is stored in the backup memory 104 when a power failure occurs.

The channel adapter 105 is an interface for communicating with the host apparatus 600. The device interface 106 is an interface for communicating with the device enclosure 410. As one example, the device interface 106 is provided as a SAS (Serial Attached SCSI) interface.

The controller module interface 107 is an interface for communicating with other controller modules via the switch 500. As one example, the controller module interface 107 is an interface circuit for a PCIe (Peripheral Component Interconnect express) bus. The controller module interface 107 is also equipped with a DMA (Direct Memory Access) controller that executes data transfers between the RAM 102 and the RAM of another controller module without passing the processor 101.

Note that the controller modules 120, 210, 220, 310, and 320 may be realized by the same hardware configuration as the controller module 110.

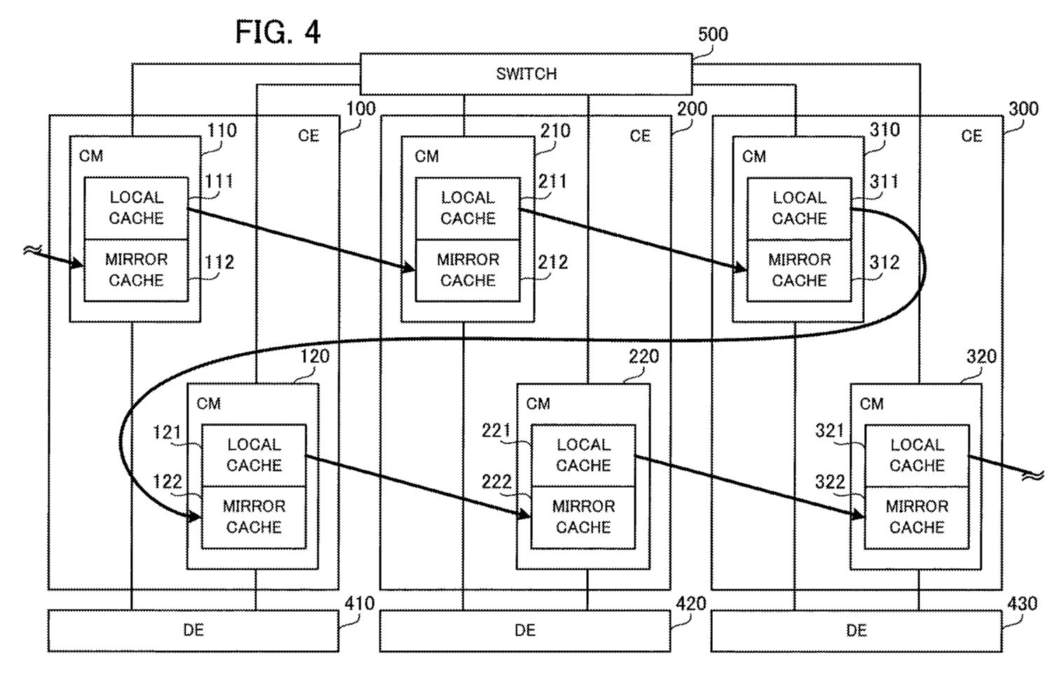

FIG. 4 depicts the relationship between cache regions and the mirror caches where the cache regions are mirrored. In the storage system according to the present embodiment, reads and writes of data between a controller module and the host apparatus 600 are performed in units of logical storage regions called “logical units” (LU). A plurality of logical units are set in the storage system, and a controller module that controls accesses from the host apparatus 600 to each LU is assigned to that LU. A controller module controls accesses to the LU assigned to that controller module using a cache region that has been reserved in the RAM of the controller module. A cache region is reserved for each LU in the RAM.

To simplify the explanation, it is assumed in FIG. 4 that the controller modules 110, 120, 210, 220, 310, and 320 each control access to one logical volume in response to access requests from the host apparatus 600.

Here, one cache region (the “local cache”, described later) is reserved in the RAM of each of the controller modules 110, 120, 210, 220, 310, and 320.

The physical storage regions corresponding to the LU subject to access control by a given controller module are realized by one or more HDDs mounted in the device enclosures 410, 420, and 430. In the simplest example, the physical regions corresponding to an LU subject to access control by a given controller module are realized by one or more HDDs mounted in the device enclosure connected to that controller module. As one example, one or more HDDs in the device enclosure 410 are assigned as physical storage regions corresponding to the LU subject to access control by the controller module 110. Normally, a plurality of HDDs are assigned to one LU, and reads and writes of data into the HDDs are controlled according to RAID (Redundant Arrays of Inexpensive Disks).

As depicted in FIG. 4, in the controller module 110, a local cache 111 and a mirror cache 112 are provided in storage regions reserved in the RAM 102. In the controller module 120, a local cache 121 and a mirror cache 122 are provided in storage regions reserved in the RAM in the controller module 120. In the controller module 210, a local cache 211 and a mirror cache 212 are provided in storage regions reserved in the RAM in the controller module 210. In the controller module 220, a local cache 221 and a mirror cache 222 are provided in storage regions reserved in the RAM in the controller module 220. In the controller module 310, a local cache 311 and a mirror cache 312 are provided in storage regions reserved in the RAM in the controller module 310. In the controller module 320, a local cache 321 and a mirror cache 322 are provided in storage regions reserved in the RAM in the controller module 320.

The local cache is used as a cache region when the corresponding controller module accesses the LU subject to access control by that controller module in response to requests from the host apparatus 600. As one example, the controller module 110 controls access to the LU in response to a request from the host apparatus 600 using the local cache 111 as a cache region. Similarly, the controller module 210 controls access to the LU in response to a request from the host apparatus 600 using the local cache 211 as a cache region.

Mirror data of another local cache is stored in a mirror cache. As one example, the controller module 110 mirrors data stored in the local cache 111 in the mirror cache 212 of the controller module 210. The controller module 210 mirrors data stored in the local cache 211 in the mirror cache 312 of the controller module 310. The controller module 310 mirrors data stored in the local cache 311 in the mirror cache 122 of the controller module 120. The controller module 120 mirrors data stored in the local cache 121 in the mirror cache 222 of the controller module 220. The controller module 220 mirrors data stored in the local cache 221 in the mirror cache 322 of the controller module 320. The controller module 320 mirrors data stored in the local cache 321 in the mirror cache 112 of the controller module 110.

In this way, the local cache of a given controller module is cyclically mirrored in a controller module in an adjacent controller enclosure. When doing so, the local cache of a given controller module will be mirrored in a controller module in a different controller enclosure to the controller enclosure in which that controller module is provided. By using this configuration, even when operations stop in units of controller enclosures, at least one of the original data and mirror data will be maintained for the cache data corresponding to every LU without being lost.

As one example, suppose that the local cache 111 of the controller module 110 were mirrored in the mirror cache 122 of the controller module 120. With this configuration, when the operation of the controller enclosure 100 stops, the data stored in the local cache 111 and the mirror data for this data which is stored in the mirror cache 122 will both be lost. On the other hand, in the example in FIG. 4, the local cache of the controller module 110 is mirrored in the mirror cache 212 of the controller module 210. This means that even when the operation of the controller enclosure 100 stops, the mirror data in the mirror cache 212 will definitely remain and conversely, even when the operation of the controller enclosure 200 stops, the original data in the local cache 111 will definitely remain.

In this way, even when the operation stops in controller enclosure units, data in one of the local cache and the mirror cache, will not be lost and will remain. On the other hand, when the operation of every controller enclosure stops due to a power failure, data in both the local cache and the mirror cache will be lost. To avoid this situation, each controller module is equipped with a nonvolatile backup memory (corresponding to the backup memory 104 in FIG. 3) for backing up the data in the cache. When a power failure occurs, dirty data in the cache region is stored in the backup memory using power supplied from the battery. As one example, the controller module 110 stores dirty data in a cache region reserved in the RAM 102 into the backup memory 104 using power supplied from the battery 140.

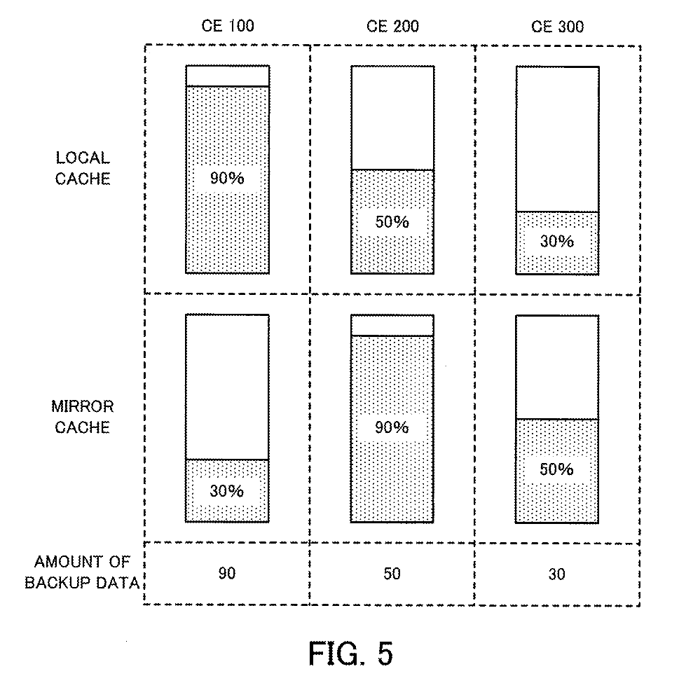

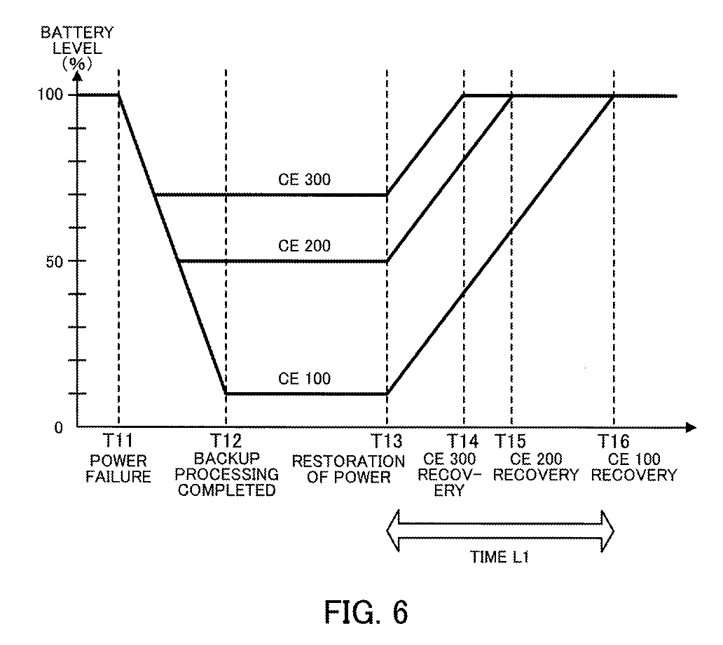

Here, issues relating to the backing up of the data in the cache region will be described with reference to FIGS. 5 and 6.

FIG. 5 depicts an example of size ratios of the dirty data stored in the cache regions. Note that in FIG. 5, the expression “the local cache of a controller enclosure” refers to all the local caches of the controller modules in that controller enclosure and the expression “the mirror cache of a controller enclosure” refers to all of the mirror caches in the controller modules in that controller enclosure. It is also assumed that the capacities of the local caches and the mirror caches of the respective controller modules are equal.

In the example in FIG. 5, dirty data that is 90% of the maximum capacity has been stored in the local cache of the controller enclosure 100. Dirty data that is 50% of the maximum capacity has been stored in the local cache of the controller enclosure 200. Dirty data that is 30% of the maximum capacity has been stored in the local cache of the controller enclosure 300. In this case, dirty data that is 30%, 90%, and 50% of the maximum capacity is stored in the mirror caches of the controller enclosures 100, 200, and 300, respectively.

Here, assume that when a power failure has occurred in the state depicted in FIG. 5, at each of the controller enclosures 100, 200, and 300, dirty data in the local cache is backed up into the backup memory. In this case, at the controller enclosures 100, 200, and 300, dirty data that is 90%, 50%, and 30% of the respective maximum capacities is stored in the corresponding backup memories.

FIG. 6 depicts example transitions in the battery level during a power failure and when power is restored. FIG. 6 depicts a case where dirty data in the local cache is stored in the backup memory at each of the controller enclosures 100, 200, and 300 when a power failure has occurred at timing T11 from the state depicted in FIG. 5. When it is assumed that the write speed into each backup memory is the same, the time taken to store the dirty data in the backup memory (i.e., the backup time) is proportional to the amount of dirty data. For the example in FIG. 6, when listed in descending order of the backup time for the dirty data, the controller enclosures are given as the controller enclosure 100, the controller enclosure 200, and the controller enclosure 300, with the backup process at the controller enclosure 100 being completed at timing T12.

Here, the discharging of the battery provided in each controller enclosure is substantially proportional to the backup time at that controller enclosure. This means that when listed in ascending order of the remaining level of the battery in each controller enclosure after the backup process, the controller enclosures are given as the controller enclosure 100, the controller enclosure 200, and the controller enclosure 300.

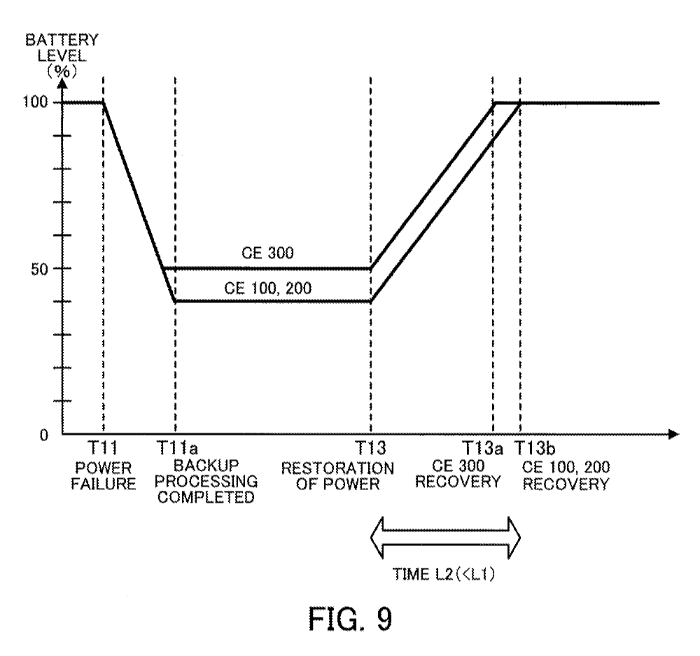

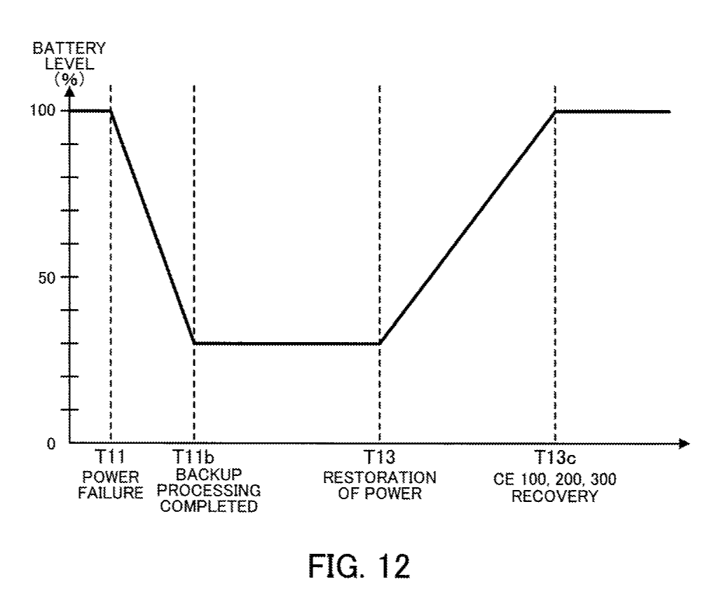

Note that each controller enclosure has two controller modules and the controller modules in a controller enclosure execute the backup process in parallel. This means that the transitions in the battery levels during the backup process depicted in FIG. 6 do not necessarily match the actual transitions. However, since the discharged amount of the battery in the controller enclosure is proportional to the total time of the backup process at each controller module in a controller enclosure, the remaining level in the battery in each controller enclosure when the backup process is completed is as depicted in FIG. 6. This also applies to FIGS. 9 and 12 described later.

Next, when power is restored at timing T13, each controller enclosure starts a recovery process that reads the dirty data from the backup memory and writes the dirty data in a cache region or a back-end storage apparatus. Together with this, at each controller enclosure, the battery is recharged using power from the power supply unit. Due to the differences in the battery level described above when the backup process is completed, the time taken until the battery is fully recharged differs between the controller enclosures. As depicted in FIG. 6, first at timing T14, the battery of the controller enclosure 300 becomes fully recharged, next, at timing T15, the battery of the controller enclosure 200 becomes fully recharged, and finally at timing T16, the battery of the controller enclosure 100 becomes fully recharged. That is, the time taken from the restoration of power until the battery becomes fully recharged will be longest in the controller enclosure 100 that has the largest amount of dirty data that is backed up.

Here, when every controller enclosure has completed the recovery process described above and the batteries have become fully recharged, the access control process to LU in response to requests from the host apparatus 600 is recommenced. In this access control process, a write-back technique is used. This means that by recommencing the access control process after the batteries become fully recharged, the controller enclosure will again be capable of backing up dirty data in the cache after the recommencement.

As in the example depicted in FIG. 6, when the remaining level of the battery when the backup process is completed differs between the controller enclosures, the time L1 from the restoration of power until the access control process is commenced by the system as a whole is decided by the recharging time at the controller enclosure with the largest amount of backup data. This means that when the stored amount of dirty data fluctuates between controller enclosures and there is a controller enclosure with a large amount of stored dirty data, there is the problem that the time L1 from the restoration of power until the access control process is recommenced by the system as a whole becomes longer.

In response to this problem, when a power failure has occurred, the storage system according to the second embodiment controls the backup process so that the amount of dirty data to be stored in a backup memory at each controller enclosure is equalized. By doing so, it is possible to increase the probability of a reduction in the largest amount of dirty data to be backed up at each controller enclosure and as a result, there is increased probability of a reduction in the time taken until it is possible to recommence the access control process by the system as a whole after the restoration of power.

According to this control, one of a first equalization method and a second equalization method is selectively used. The first equalization method focuses on a local cache and the mirror cache corresponding to the local cache being present in different controller enclosures. According to this method, some of the dirty data in the local cache of a given controller enclosure is stored from the mirror cache of the adjacent controller enclosure in the backup memory of that controller enclosure so as to equalize the amount of data backed-up in the backup memory in each controller enclosure. On the other hand, the second equalization method moves dirty data between local caches so as to equalize the amount of data backed-up in the backup memory in each controller enclosure.

The controller enclosures 100, 200, and 300 in the second embodiment will now be described in more detail.

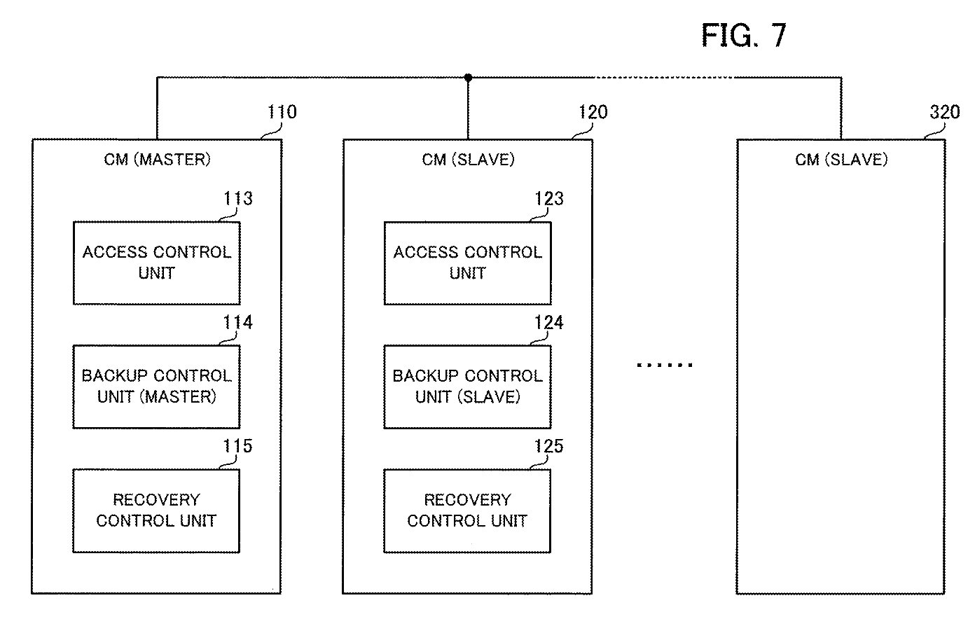

FIG. 7 depicts an example configuration of the processing functions provided in a controller module. In the present embodiment, in the processing when there is a power failure and when power is restored, one controller module out of the controller modules 110, 120, 210, 220, 310, and 320 operates as a master and the remaining controller modules operate as slaves. As one example in the following description, it is assumed that the controller module 110 is the master and the controller modules 120, 210, 220, 310, and 320 are the slaves. Note also that in the following description, the controller module 110 is sometimes referred to as the “master controller module” and the controller modules 120, 210, 220, 310, and 320 are sometimes referred to as “slave controller modules”.

The controller module 110 includes an access control unit 113, a backup control unit 114, and a recovery control unit 115. As one example, the processing of the access control unit 113, the backup control unit 114, and the recovery control unit 115 is realized by the processor 101 provided in the controller module 110 executing predetermined application programs.

The access control unit 113 controls access to predetermined LU in response to a request from the host apparatus 600 while using the local cache 111 as a cache. The access control unit 113 also mirrors the data stored in the local cache 111 in the mirror cache 212 of the controller module 210.

Here, the access control unit 113 controls writes to LU according to a write back technique. When a write to an LU has been requested from the host apparatus 600, the access control unit 113 stores the write data in the local cache 111 and the mirror cache 212 and then sends a write complete reply to the host apparatus 600. The access control unit 113 writes the write data written into the local cache 111 into the physical storage region corresponding to the LU later at predetermined timing.

Note that although not illustrated, management information, in which identification information of LU (or “logical unit numbers” (LUN)) and information indicating the assignment destination controller modules where the local cache and mirror cache are to be assigned are associated, is stored in a storage unit (the SSD 103 for example) of the controller module 110. The assignment destination controller module of the local cache indicates the controller module in charge of access control to the corresponding LU using that local cache. The access control unit 113 determines, based on the management information, the LU subject to access control by the controller module 110 and the controller module to which the mirror cache is assigned. This management information also serves as definition information that defines the cyclic arrangement of controller modules (or controller enclosures) produced by the positional relationship of the local caches and the corresponding mirror caches.

The backup control unit 114 is a processing function as a master. When a power failure has occurred, the backup control unit 114 controls execution of the backup process for protecting the dirty data stored in the local cache 111. More specifically, when a power failure has occurred, the backup control unit 114 gathers the data amounts of dirty data in the local caches from all of the controller modules. The backup control unit 114 then determines, based on the gathered data amounts, which of the first equalization method and the second equalization method is capable of reducing the amount of backed-up data in each controller module. Based on the determination result, the backup control unit 114 controls the execution of a backup process using one of the two methods.

When the first equalization method is used, the backup control unit 114 notifies each slave controller module of which regions in the local caches and the mirror caches have dirty data that is to be backed up and instructs the slave controller modules to store the dirty data into the backup memories. Together with this, the backup control unit 114 stores the dirty data to be backed up in the local cache 111 and the mirror cache 112 of the controller module 110 into the backup memory 104.

When the second equalization method is used, the backup control unit 114 has the movement of data executed between local caches. After the movement of data is complete, the backup control unit 114 notifies each slave controller module of which regions of the local caches have dirty data that is to be backed up and instructs the salve controller modules to store the dirty data into the backup memories. Together with this, the backup control unit 114 stores the dirty data to be backed up in the local cache 111 of the controller module 110 into the backup memory 104.

The recovery control unit 115 executes a process that reads out the dirty data backed up in the backup memory 104 and writes the read-out dirty data back into a predetermined storage apparatus. In this process, out of the dirty data that has been read out, the recovery control unit 115 stores data in the LU subject to control by the controller module 110 into a back end storage apparatus corresponding to the LU. Out of the dirty data that has been read out, the recovery control unit 115 also transmits data of the LU subject to control by other controller modules to the other controller modules. In addition, out of the dirty data of LU subject to control by the controller module 110, the recovery control unit 115 receives data that was backed up in the backup memory of other controller modules from the other controller modules and stores the data in a back-end storage apparatus corresponding to the LU.

The controller module 120 includes an access control unit 123, a backup control unit 124, and a recovery control unit 125. As one example, the processing of the access control unit 123, the backup control unit 124, and the recovery control unit 125 is realized by a processor provided in the controller module 120 executing predetermined application programs.

Since the access control unit 123 and the recovery control unit 125 execute the same processing as the access control unit 113 and the recovery control unit 115, description thereof is omitted here.

The backup control unit 124 is a processing function as a slave. When a power failure has occurred, the backup control unit 124 transmits, in response to an instruction from the master controller module, information that makes it possible to determine the amount of dirty data stored in the local cache 121 to the master controller module. After this, in accordance with an instruction from the master controller module, the backup control unit 124 reads out designated dirty data from the local cache 121 and/or the mirror cache 122 and stores the data in the backup memory of the controller module 120. Also, when the second equalization method is used, before storing data in the backup memory, the backup control unit 124 transmits dirty data from the local cache 121 to other controller modules and/or receives dirty data from other controller modules.

Note that although not illustrated, the controller modules 210, 220, 310, and 320 that operate as slaves have the same processing function as the controller module 120.

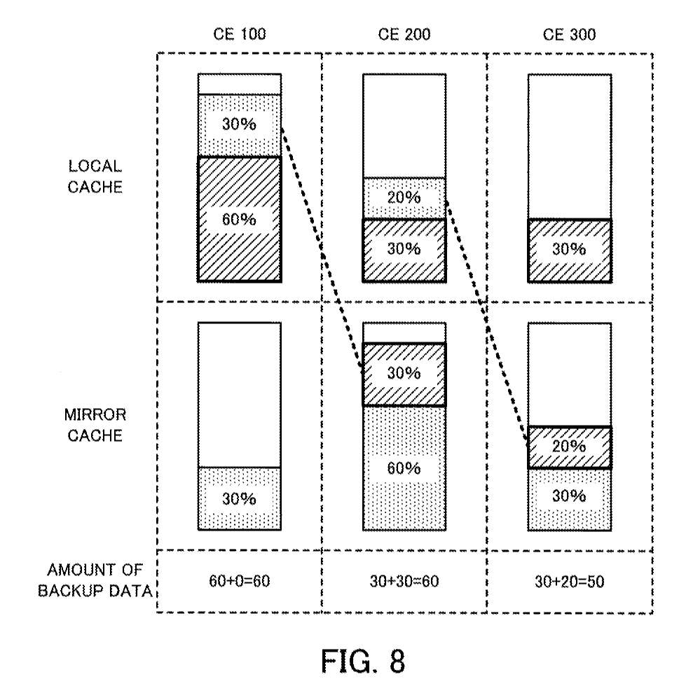

The first equalization method will now be described with reference to FIGS. 8 to 10.

FIG. 8 depicts an example setting of how data is backed up when the first equalization method is used. In FIG. 8, it is assumed that dirty data has been stored in each local cache and each mirror cache as depicted in FIG. 5.

Note that in the following description, for ease of explanation, the amount of dirty data is expressed as a percentage of the maximum capacity of a local cache and a mirror cache. As one example, when an amount of dirty data equal to 90% of the maximum capacity of the local cache is stored, this is expressed as “90” dirty data being stored in the local cache.

With the first equalization method, the amounts of data backed up in the backup memories of the respective controller enclosures are equalized by storing some of the dirty data in the local cache of a given controller enclosure from the mirror cache of an adjacent controller enclosure into the backup memory of the adjacent controller enclosure. In the example in FIG. 8, out of the “90” dirty data stored in the local cache of the controller enclosure 100, “30” dirty data are backed up in the backup memory of the controller enclosure 200 from the mirror cache of the controller enclosure 200. Similarly, out of the “50” dirty data stored in the local cache of the controller enclosure 200, “20” dirty data are backed up in the backup memory of the controller enclosure 300 from the local cache of the controller enclosure 300. Meanwhile all “30” dirty data stored in the local cache of the controller enclosure 300 are backed up in the backup memory of the controller enclosure 300.

By performing this backup process, the amounts of data backed up in the respective backup memories of the controller enclosures 100, 200, and 300 become “60”, “60”, and “50”, which are substantially equal. Also, at the controller enclosure 100, the amount of backed-up data is reduced to ⅔ compared to a case where all of the dirty data in the local cache is backed up in the backup memory of the controller enclosure 100.

FIG. 9 depicts example transitions in the battery level during a power failure and during restoration of power. In FIG. 9, it is assumed that the data to be backed up is set as depicted in FIG. 8. Note that for ease of explanation, focus is placed on only discharging of the battery due to writes into backup memory.

After a power failure has occurred at timing T11, the dirty data is backed up as depicted in FIG. 8. In this case, at timing T11a that is earlier than timing T12 in FIG. 6, the backup process is completed at all of the controller enclosures 100, 200, and 300. Accordingly, the remaining levels of the respective batteries of the controller enclosures 100, 200, and 300 when the backup processes are completed are at least 40%, which is clearly higher than the 10% level in FIG. 6.

After this, once power is restored at timing T13 and the recharging of the batteries of the controller enclosures 100, 200, and 300 has commenced, the battery of the controller enclosure 300 becomes fully recharged at timing T13a, and the batteries of the controller enclosures 100 and 200 become fully recharged at timing T13b. As described above, since the minimum battery level when the backup processes are completed is higher than with the case depicted in FIG. 6, the time L2 from restoration of power to the timing T13b when all of the batteries become fully recharged is shorter than the time L1 depicted in FIG. 6. Accordingly, the time taken from restoration of power until access control according to a write-back technique is commenced by every controller module, that is, the recovery time for the system as a whole is reduced.

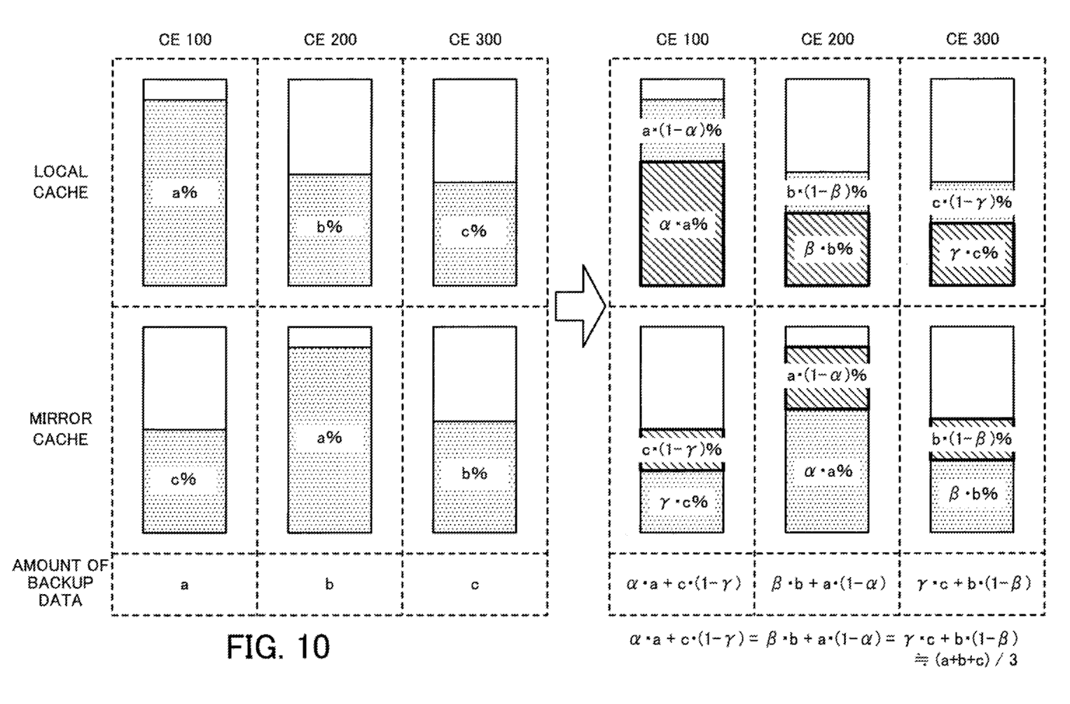

FIG. 10 depicts a method of calculating the amount of data to be backed up in each cache region. When the first equalization method is used, the amount of data to be backed up in each cache region is calculated according to the following method.

The amounts of dirty data stored in the respective local caches of the controller enclosures 100, 200, and 300 are assumed to be “a”, “b”, and “c”. In this case, the amounts of dirty data stored in the respective mirror caches of the controller enclosures 100, 200, and 300 are “c”, “a”, and “b”. The ratio of the data to be backed up out of the dirty data in the local cache of the controller enclosure 100 is expressed as α. The ratio of the data to be backed up out of the dirty data in the local cache of the controller enclosure 200 is expressed as β. The ratio of the data to be backed up out of the dirty data in the local cache of the controller enclosure 300 is expressed as γ. Here, α, β, and γ each take values that are between 0 and 1, inclusive.

The master controller module finds a solution for α, β, γ so that “α·a+c·(1−γ)”, “β·b+a·(1−α)”, and “γ·c+b·(1−β)” substantially match (as one example, so that the differences between these values are within a certain range). In reality, a more suitable solution is obtained by finding a solution such that “α·a+c·(1−γ)”, “β·b+a·(1−α)”, and “γ·c+b·(1−β)” are substantially equal to the average amount of dirty data, which is “(a+b+c)/3”.

The dirty data is then backed up as follows using the obtained α, β, and γ. At the controller enclosure 100, an amount “α·a” of dirty data in the local cache and an amount “c·(1−γ)” of dirty data in the mirror cache are stored in the backup memory of the controller enclosure 100. At the controller enclosure 200, an amount “β·b” of dirty data in the local cache and an amount “a·(1−α)” of dirty data in the mirror cache are stored in the backup memory of the controller enclosure 200. At the controller enclosure 300, an amount “γ·c” of dirty data in the local cache and an amount “b·(1−β)” of dirty data in the mirror cache are stored in the backup memory of the controller enclosure 300.

Note that the amount of backed-up data from the local caches or the mirror caches in a controller enclosure is the total amount of backed-up data from the local caches or mirror caches of the respective controller modules in that controller enclosure. The ratios of the amounts of backed-up data from the local caches or mirror caches of the respective controller modules in a single controller enclosure may be set as desired. As one example, when backing up the amount “α·a” of dirty data from the local caches of the controller enclosure 100, dirty data from the local cache 111 of the controller module 110 may be backed up with priority and dirty data from the local cache 121 of the controller module 120 may also be backed up when the amount of backed-up data has not reached “α·a”.

The first equalization method described above is used only when it has been determined that the backup processing time is shorter than when the second equalization method is used. Also, depending on the values of the data amounts “a”, “b”, and “c”, there are cases where a valid solution of α, β, and γ (for example, a solution with values of 0 or greater) is not obtained with the calculation method described above, and in these cases also, the second equalization method is used.

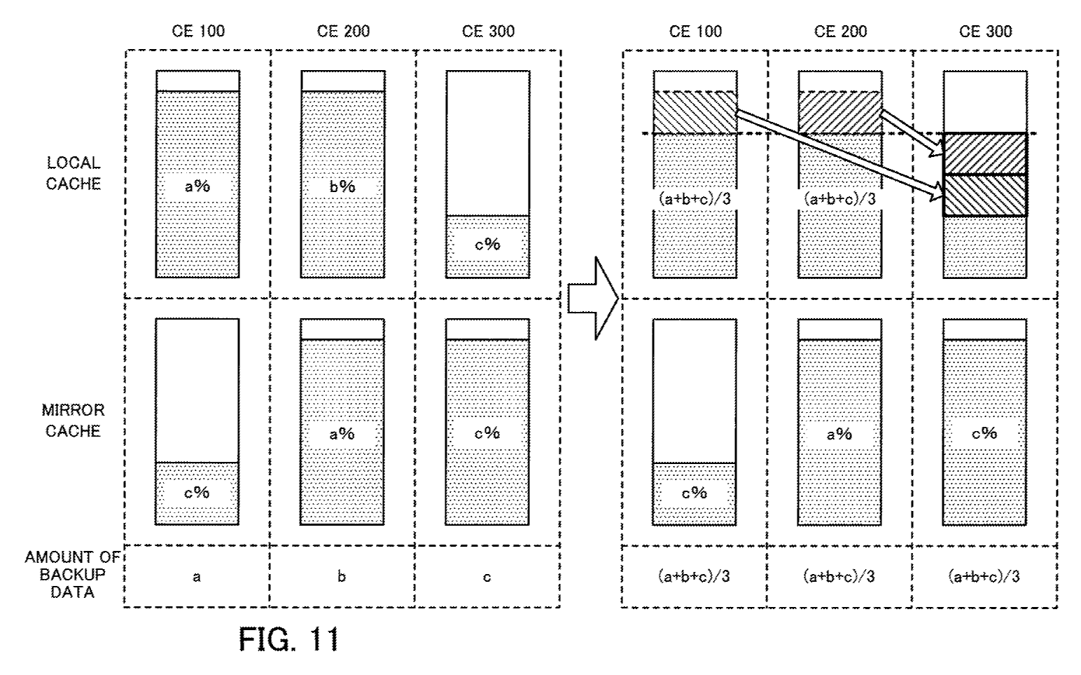

Next, the second equalization method will be described with reference to FIGS. 11 and 12.

FIG. 11 depicts an example setting of how data is backed up when the second equalization method is used. With the second equalization method, by moving dirty data between the local caches of the respective controller enclosures, the amount of data to be backed up in the backup memory of each controller enclosure is equalized. As one example, it is assumed that dirty data is stored in the local cache and the mirror cache of the controller enclosures 100, 200, and 300 as depicted on the left in FIG. 11. Here, an amount of dirty data in excess of the average amount of dirty data in the local caches is moved from the local cache of a given controller enclosure to the local caches of other controller enclosures where the amount of dirty data has not reached the average amount. Note that the average amount of dirty data is calculated as “(a+b+c)/3”.

In the example in FIG. 11, out of the dirty data of the local cache of the controller enclosure 100, an amount of dirty data in excess of the average amount of dirty data is moved to the local cache of the controller enclosure 300. Together with this, out of the dirty data in the local cache of the controller enclosure 200, an amount of dirty data in excess of the average amount of dirty data is also moved to the local cache of the controller enclosure 300. After this, an average amount of dirty data is stored from the respective local caches of the controller enclosures 100, 200, and 300 into the corresponding backup memories. By doing so, the largest amount of data to be backed up in the controller enclosures is suppressed to the average amount of data.

FIG. 12 depicts example transitions in the battery level during a power failure and when power is restored. In FIG. 12, it is assumed that dirty data of local caches has been moved as depicted on the right in FIG. 11.

After a power failure occurred at timing T11, data movement is performed as depicted in FIG. 11 and the dirty data is backed up. Here, at timing T11b that is earlier than timing T12 in FIG. 6, the backup process is completed for all of the controller enclosures 100, 200, and 300. Accordingly, the remaining levels of the respective batteries of the controller enclosures 100, 200, and 300 when the backup processes are completed are at least 30%. This value is clearly higher than the 10% value when dirty data of the respective local caches of the controller enclosures 100 and 200 has been stored in a backup memory from the state on the left in FIG. 11.

After this, when power is restored at timing T13 and recharging of the batteries of the controller enclosures 100, 200, and 300 has commenced, the batteries of the controller enclosures 100, 200, and 300 become fully charged at timing T13c. The time from the restoration of power to timing T13c when all of the batteries become fully recharged is shorter than when the dirty data of the respective local caches is backed up from the state depicted on the left in FIG. 11. Accordingly, the time taken from the restoration of power until access control according to a write-back technique is commenced by every controller module, that is, the recovery time for the system as a whole is reduced.

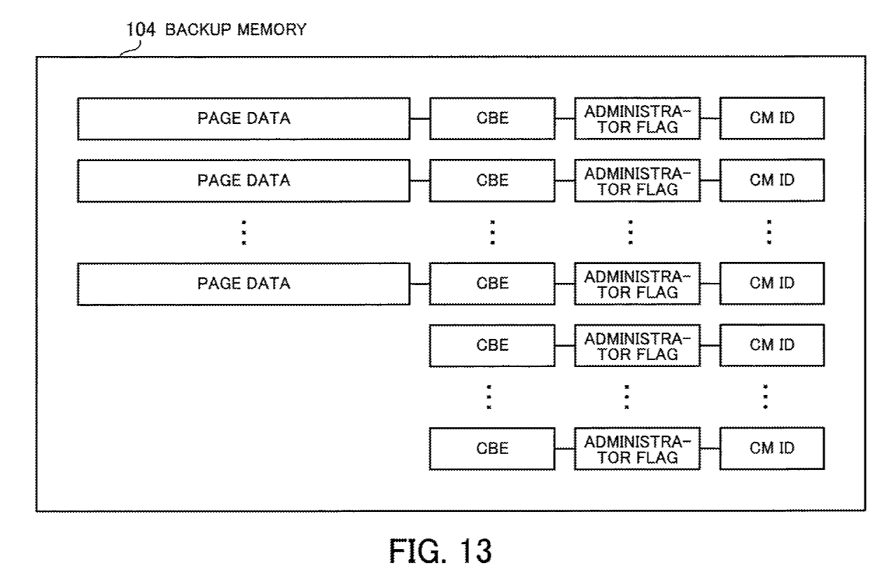

FIG. 13 depicts an example configuration of data to be stored in the backup memories. As one example in FIG. 13, an example configuration of the data to be stored in the backup memory 104 of the controller module 110 is depicted.

In the present embodiment, a cache region is managed by being divided into pages of a fixed size. A predetermined number of data blocks are written onto each page. Each page is stored in association with page management information called a cache bundle element (CBE). Identification information of the page, an LUN and an LBA (Logical Block Address) of each data block included on the page, a status flag indicating whether each data block is dirty data, and the like are registered in a CBE. Note that the LBA is the logical address of a data block in an LUN. Data blocks with the same LUN are stored on one page.

The master CM calculates the amount of dirty data in each local cache by gathering the CBE from each slave CM and the master CM itself. The master CM determines that data on a page that includes at least one data block with a status flag that indicates dirty data is dirty data. Accordingly, the master CM calculates the amount of dirty data in page units. The master CM then designates regions to be backed up in the local cache and/or the mirror cache in page units.

As depicted in FIG. 13, as one example, page data, a CBE, an administrator flag and a controller module ID are set as one set in the backup memory 104. The page data is data blocks included in a page. Note that there are also cases where the page data is not stored in the backup memory 104. The CBE is page management information corresponding to a page where page data was stored. The administrator flag is flag information indicating whether the LU in which the page data is included is subject to access control by the present apparatus (for the example in FIG. 13, the controller module 110). Here, it is assumed that when the present apparatus is the administrator controller module, the administrator flag is set at “1”, while when another controller module is the administrator controller module, the administrator flag is set at “0”. The controller module ID is the identification number of a controller module indicating the controller module in whose cache region the page data is stored.

As one example, for page data backed up from the local cache 111 of the controller module 110, the administrator flag is set at “1” and the controller module ID indicates the controller module 110. In this case, after the restoration of power, the dirty data in a page data is written back into the corresponding storage apparatus by the controller module 110.

Also, for page data backed up from the mirror cache 112 of the controller module 110, the administrator flag is set at “0” and the controller module ID indicates the controller module 320. In this case, after the restoration of power, the page data is transferred to the controller module 320 and the dirty data in the page data is written back into the corresponding storage apparatus by the controller module 320.

Also, for page data backed up after movement to the controller module 110 from another controller module, the administrator flag is set at “0” and the controller module ID indicates the controller module from which the data has been moved. In this case, after the restoration of power, the page data is transferred to the other controller module indicated by the controller module ID and the dirty data in the page data is written back into the corresponding storage apparatus by the controller module to which the data has been transferred.

For page data backed up in another controller module out of the page data that includes dirty data in the local cache 111 of the controller module 110, only the CBE, the administrator flag, and the controller module ID are stored in the backup memory 104. In this case, the administrator flag is set at “1” and the controller module ID indicates the controller module 110. After the restoration of power, a CBE that is not associated with the page data in this way is used to confirm whether all of the page data has been transmitted from another controller module to the controller module 110.

Next, the processing of a controller module will be described by way of flowcharts.

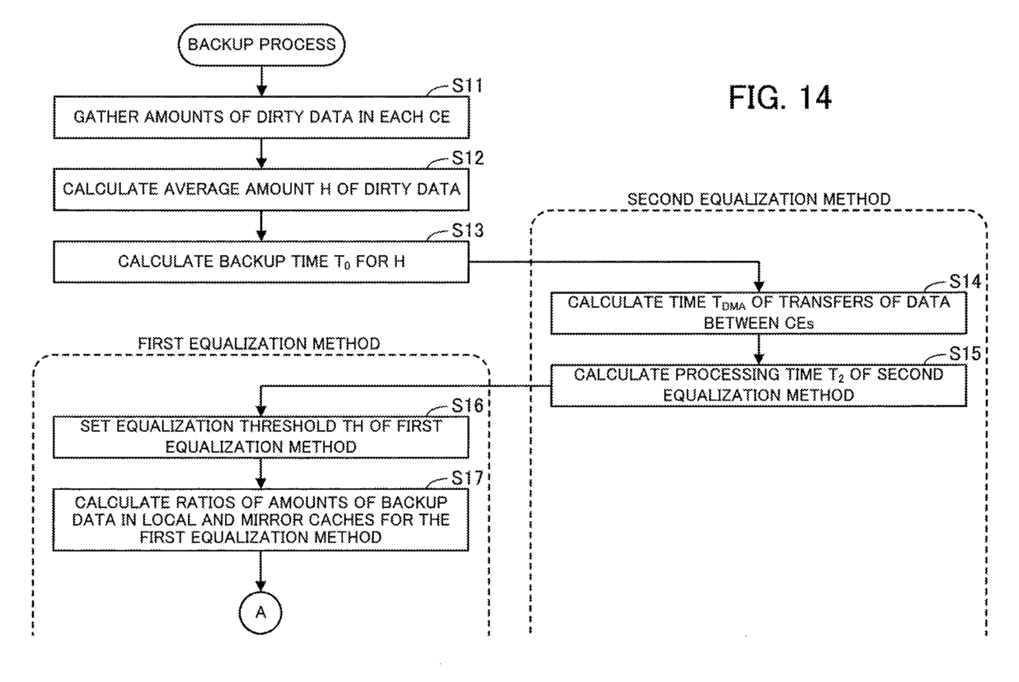

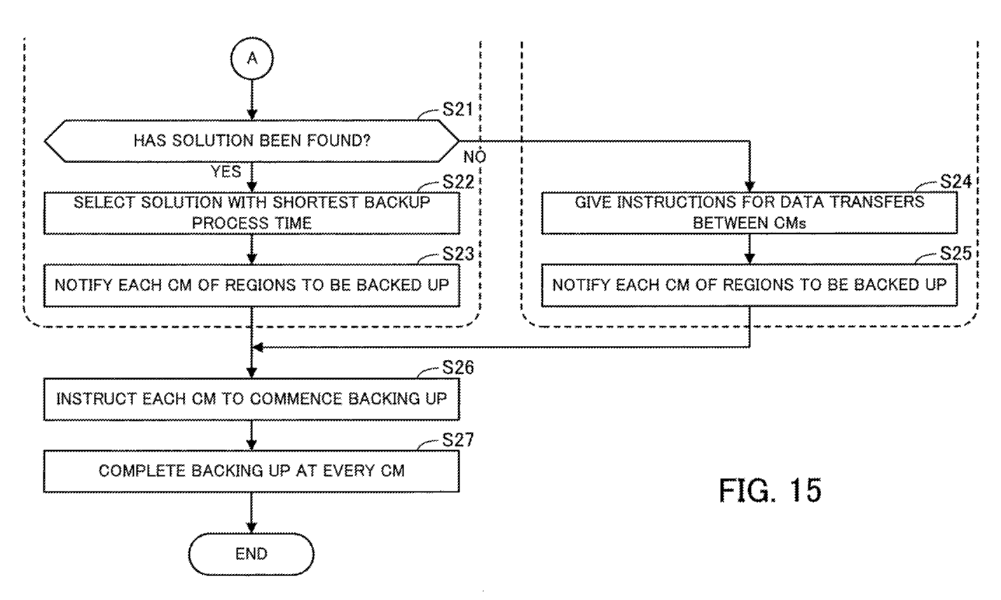

FIGS. 14 and 15 are a flowchart depicting an example procedure of the backup processing by the master controller module. When the backup control unit 114 of the controller module 110 that is the master CM detects that a power failure has occurred, the processing depicted in FIG. 14 is commenced. As one example, the occurrence of a power failure is detected from the source of the supplied power switching from the power supply unit 130 to the battery 140.

Note that in FIGS. 14 and 15, steps S16, S17, and S21 to S23 correspond to the processing of the first equalization method and steps S14, S15, S24, and S25 correspond to the processing of the second equalization method.

(Step S11) The backup control unit 114 gathers the amounts of dirty data stored in the local caches of the controller enclosures 100, 200, and 300. More specifically, the backup control unit 114 gathers every CBE from the respective controller modules. Every CBE registered in the controller module 110 is also gathered. The backup control unit 114 calculates the amount of dirty data based on the status flags in the CBE gathered for each controller enclosure.

(Step S12) The backup control unit 114 calculates the average amount H of dirty data stored in each local cache of the controller enclosures 100, 200, and 300. As described earlier, when the amounts of dirty data stored in the respective local caches of the controller enclosures 100, 200, and 300 are expressed as “a”, “b”, and “c”, the average amount H is calculated as “(a+b+c)/3”.

(Step S13) The backup control unit 114 calculates the backup time T₀ when the average amount H of dirty data is backed up at one controller enclosure. Here, when the data transfer speed from the RAM 102 to the backup memory 104 is assumed to be S_{BM}, the backup times T₀ is calculated as “H/S_{BM}”.

(Step S14) The backup control unit 114 calculates the transfer time T_{DMA} taken by DMA transfer between controller enclosures when the second equalization method is used. In this process, the backup control unit 114 first selects controller enclosures where the amount of dirty data in the local cache is the average amount H or larger. The backup control unit 114 calculates, for the dirty data in the local cache of each selected controller enclosure, the amount of data that exceeds the average amount H and sums the amounts of data calculated for each controller enclosure. The backup control unit 114 calculates the transfer time T_{DMA} by dividing the total amount of data by the transfer speed of DMA transfers.

(Step S15) The backup control unit 114 calculates the processing time T₂ when the second equalization method is used. The processing time T₂ is calculated as “T₀+T_{DMA}”.

(Step S16) The backup control unit 114 sets the equalization threshold TH to be used when using the first equalization method. The equalization threshold TH is calculated as “S_{BM}·T₂”.

(Step S17) The backup control unit 114 calculates the ratio of the amounts of data to be backed up from the local cache and the mirror cache when the first equalization method is used. This calculation finds the values of α, β, and γ depicted in FIG. 10. When there are three controller enclosures as in the example in FIG. 10, a solution that makes “α·a+c·(1−γ)”, “β·b+a·(1−α)”, and “γ·c+b·(1−β)” substantially equal to the average amount H (for example, within a certain range that is centered on the average amount H) is found. In addition to this condition, a solution that prevents “α·a+c·(1−γ)”, “β·b+a·(1−α)”, and “γ·c+b·(1−β)” from exceeding the equalization threshold TH calculated in step S16 is found.

After this, the processing in step S21 of FIG. 15 is executed.

(Step S21) The backup control unit 114 determines whether it was possible to find a solution that satisfies the condition in step S17. When a solution was found, it is determined that the backup processing time is shorter (i.e., the amount of discharging of the battery is less) when the first equalization method is used for every controller enclosure. In this case, the processing in step S22 is executed. On the other hand, when a solution was not found, it is determined that there is a controller enclosure for which the backup processing time is shorter (i.e., the amount of discharging of the battery is less) when the second equalization method is used. In this case, the processing in step S24 is executed.

(Step S22) When a plurality of solutions that satisfy the condition in step S17 have been obtained, the backup control unit 114 selects the solution with the shortest backup processing time out of these solutions.

(Step S23) The backup control unit 114 notifies each slave controller module of the backed-up regions in the local cache and the mirror cache based on the found solution. In the present embodiment, the backed-up regions are designated in page units. The backup control unit 114 also sets the backed-up regions in the master controller module 110 in the memory region of the controller module 110.

(Step S24) The backup control unit 114 gives instructions for data transfers between the controller modules. In this process, one or both controller modules in a controller enclosure where the amount of dirty data in the local cache exceeds the average amount H is notified of the pages to be transferred and the transfer destination controller modules. Note that the master controller module 110 may also be notified. The controller module(s) that has/have been notified perform DMA transfer of the data on the designated pages and the corresponding CBE to the designated transfer destination controller modules.

(Step S25) The backup control unit 114 notifies every slave controller module of the regions in their local caches to be backed up. In the same way as in step S23, the backed-up regions are designated in page units. The backup control unit 114 also sets the backed-up regions of the master controller module 110 in the memory region of the controller module 110.

(Step S26) The backup control unit 114 instructs each slave controller module to start backing up in the respective backup memories. The backup control unit of each slave controller module that has been instructed executes backing up as described below, for example.

The backup control unit stores the page data of the pages in the local cache designated in step S23 or step S25 together with the corresponding CBE, the administrator flag, and the controller module ID in the backup memory. The administrator flag is set at “1” and the controller module ID is set at an ID indicating that slave controller module.

The backup control unit also extracts pages including dirty data from the pages in the local cache of that slave controller module. The backup control unit stores the CBE, administrator flags, and controller module IDs corresponding to the pages, out of the pages including dirty data, that were not designated in step S23 or S25 in the backup memory. The administrator flags are set at “1” and the controller module IDs are set at the ID indicating that slave controller module. The page data for these pages is not backed up and the stored information is used to confirm reception when corresponding page data is received from another controller module after the restoration of power.

When a page in the mirror cache is designated in step S23, the backup control unit stores the page data of that page together with the corresponding CBE, the administrator flag, and the controller module ID in the backup memory. The administrator flag is set at “0” and the controller module ID is set at the ID of the adjacent controller module in which the original data for that mirror data is stored.

When page data and a CBE have been received from another controller module in step S24, the backup control unit stores the received page data and the CBE together with the administrator flag and the controller module ID in the backup memory. The administrator flag is set at “0” and the controller module ID is set at the ID of the controller module that transmitted the page data.

The backup control unit 114 of the master controller module executes backing up to the backup memory 104 of the controller module 110 using the same procedure as the backup control unit of a slave controller module.

(Step S27) The backup control unit 114 stands by until the backup process is completed at every controller module. When every controller module has completed the backup process, the backup control unit 114 ends the processing.

According to the processing in FIGS. 14 and 15 described above, it is determined whether the largest discharging amount of the batteries in the controller enclosures is reduced when one of the first equalization method and the second equalization method is used. Based on the determination result, a backup process that uses the appropriate equalization method is then executed. By doing so, it is possible to minimize the largest discharging amount of the batteries in the controller enclosures. As a result, it is possible to increase the probability of a reduction in the time taken until the battery of every controller enclosure is fully recharged after the restoration of power, and therefore possible for the system as a whole to recover more quickly.

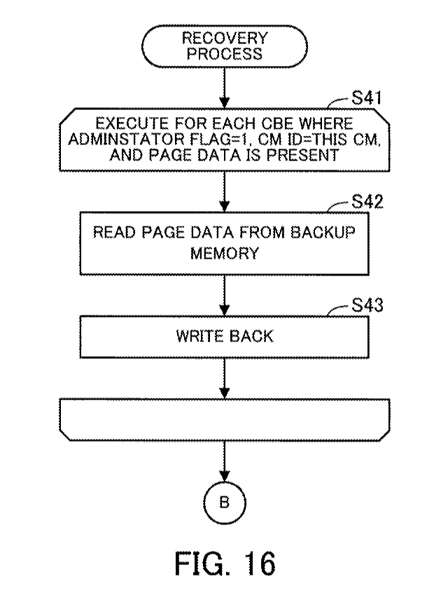

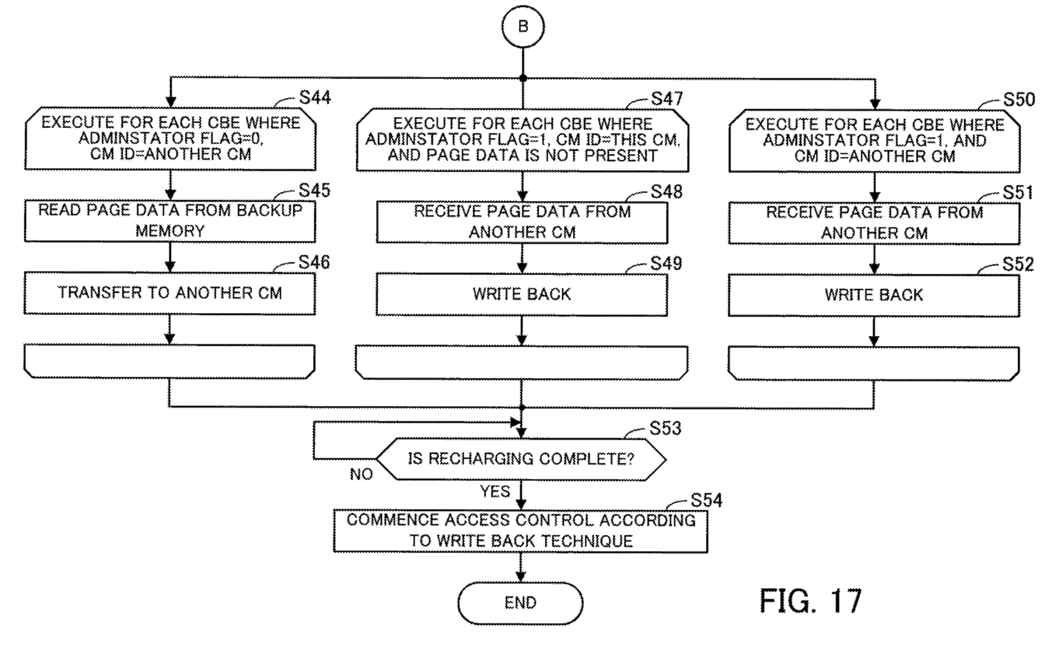

FIGS. 16 and 17 are a flowchart depicting an example procedure of the recovery process of a controller module when power is restored. Note that as one example, the recovery process at the controller module 120 is described here. When the supplying of power from the power supply unit 130 is recommenced and the controller module 120 is activated, the recovery control unit 125 of the controller module 120 starts the processing in FIG. 16.

(Step S41) The recovery control unit 125 executes the processing in steps S42 and S43 for every CBE that satisfies the following condition out of the CBE stored in the backup memory of the controller module 120. The condition is that the corresponding administrator flag is “1”, the corresponding controller module ID indicates the controller module 120, and the corresponding page data is stored in the backup memory.

(Step S42) The recovery control unit 125 reads the page data corresponding to the CBE from the backup memory.

(Step S43) The recovery control unit 125 writes the dirty data in the read page data back into a predetermined storage apparatus.

When the processing in steps S42 and S43 has been executed for every CBE that satisfies the condition given in step S41, the processing in steps S44 to S46, the processing in steps S47 to S49, and the processing in steps S50 to S52 are executed in parallel.

(Step S44) Out of the CBE stored in the backup memory of the controller module 120, the recovery control unit 125 executes the processing in steps S45 and S46 for every CBE that satisfies the following condition. The condition is that the corresponding administrator flag is “0” and the corresponding controller module ID indicates another controller module aside from the controller module 120. When there is no CBE that satisfies this condition, steps S45 and S46 are skipped.

(Step S45) The recovery control unit 125 reads the page data corresponding to the CBE from the backup memory. Note that the read page data corresponds to page data that was backed up from the mirror cache using the first equalization method or page data that was transferred from another controller module using the second equalization method.

(Step S46) The recovery control unit 125 performs a DMA transfer of the read page data and the corresponding CBE to the other controller module indicated by the corresponding controller module ID.

(Step S47) The recovery control unit 125 executes the processing in steps S48 and S49 for every CBE that satisfies the following condition out of the CBE stored in the backup memory of the controller module 120. The condition is that the corresponding administrator flag is “1”, the corresponding controller module ID indicates the controller module 120, and the corresponding page data is not stored in the backup memory of the controller module 120. When there is no CBE that satisfies this condition, steps S48 and S49 are skipped.

(Step S48) The recovery control unit 125 receives page data and a CBE from another CM. Note that the received page data corresponds to page data that was backed up in a backup memory from the mirror cache in another controller module which is adjacent using the first equalization method.

(Step S49) When the LUN and LBA in the received CBE match the LUN and LBA registered in one CBE that matches the condition given in step S47, the recovery control unit 125 writes the received page data back into the predetermined storage apparatus.

(Step S50) The recovery control unit 125 executes the processing in steps S51 and S52 for every CBE that satisfies the following condition out of the CBE stored in the backup memory of the controller module 120. The condition is that the corresponding administrator flag is “1” and the corresponding controller module ID indicates another controller module aside from the controller module 120. When a CBE satisfies this condition, the page data corresponding to that CBE is not stored in the backup memory of the controller module 120. Also, when a CBE that satisfies this condition is not present, steps S51 and S52 are skipped.

(Step S51) The recovery control unit 125 receives page data and a CBE from another controller module. Note that the received page data corresponds to page data that was transferred from the controller module 120 to another controller module and backed up in the backup memory of the other controller module using the second equalization method.

(Step S52) When the LUN and the LBA in the received CBE match the LUN and the LBA registered in one CBE that satisfies the condition given in step S50, the recovery control unit 125 writes the received page data back into a predetermined storage apparatus.

(Step S53) The recovery control unit 125 determines whether the recharging of the battery 140 provided in the controller enclosure 100 has been completed. When the recharging has not been completed, the processing in step S53 is executed once again after a certain time. When charging has been completed, the processing of step S54 is executed.

(Step S54) The recovery control unit 125 commences access control for the LU according to a write-back technique using the local cache 121.

Note that FIGS. 16 and 17 described above depict an example where the controller modules autonomously execute the recovery process after restoration of power. However, as another example, a configuration where the recovery process is executed under the control of a master controller module is also conceivable. In this case, management information indicating what page data of what controller module was backed up in what controller module when there was a power failure is stored in the backup memory of the master controller module. After the restoration of power, the master controller module refers to the stored management information and controls execution of transfers between controller modules of page data read from the backup memories and the writing back of page data at the controller modules.

The processing functions of the apparatuses (as examples, the storage control apparatuses 10, 20, and 30 and the controller modules 110, 120, 210, 220, 310, and 320) described in the above embodiments may also be realized by a computer. By providing a program in which the processing content of the functions to be implemented in the respective apparatuses is written and having a computer execute this program, the processing functions described above are realized on a computer. The program in which the processing content is written may be recorded in advance on a computer-readable recording medium. Examples of a computer-readable recording medium include a magnetic storage apparatus, an optical disc, a magneto-optical recording medium, and a semiconductor memory. Hard disk drives (HDDs), flexible disks, and magnetic tape are all examples of magnetic storage apparatuses. DVD (Digital Versatile Disc), DVD-RAM, CD-ROM (Compact Disc-Read Only Memory), CD-R (Recordable) and CD-RW (Rewritable) are all examples of optical discs. An MO (Magneto-Optical) disc is one example of a magneto-optical recording medium.

When the program is distributed, as one example portable recording media such as DVDs or CD-ROMs on which the program is recorded may be sold. It is also possible to store the program in a storage apparatus of a server computer and to transfer the program from the server computer via a network to another computer.

For example, the computer that executes the program stores the program recorded on a portable recording medium or the program transferred from a server computer into its own storage apparatus. The computer then reads the program from its own storage apparatus and executes processing in accordance with the program. Note that it is also possible for the computer to directly read the program from the portable recording medium and execute processing in accordance with the program. It is also possible for a computer to execute processing in accordance with a received program every time a program is transferred from a server computer connected via a network.

According to the present embodiments, it is possible to increase the probability that the drop in battery level due to a backup process performed when a power failure has occurred is suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage system comprising:
a power supply; and
a plurality of storage control apparatuses that are placed in a cyclic arrangement and operate on power supplied from the power supply,
wherein the plurality of storage control apparatuses each include:
a volatile memory including a cache region and a mirror cache region;
a nonvolatile memory;
a processor that mirrors data stored in the cache region to the mirror cache region of another storage control apparatus that is adjacent in a predetermined direction in the cyclic arrangement of the plurality of storage control apparatuses; and
a battery that supplies power for storing data from the volatile memory into the nonvolatile memory when there is a power failure for the power supply,
wherein the processor of a master apparatus decided in advance out of the plurality of storage control apparatuses:
classifies, at each of the plurality of storage control apparatuses when there is a power failure for the power supply, dirty data stored in the cache region into first data and second data, and designates the first data stored in the cache region as first backup data and mirror data of the second data, which is stored in the mirror cache region of said another storage control apparatus adjacent in the predetermined direction, as second backup data, wherein classification of the dirty data includes deciding a ratio of data amounts of the first data and the second data for each of the plurality of storage control apparatuses so that differences between the storage control apparatuses in a total amount of the first backup data designated in the cache region and the second backup data designated in the mirror cache region are within a predetermined range; and
controls the plurality of storage control apparatuses so that each of the plurality of storage control apparatuses stores the first backup data and the second backup data in the nonvolatile memory.

2. The storage system according to claim 1,
wherein when there is a power failure for the power supply, the processor of the master apparatus selectively executes, based on the total amount at each of the plurality of storage control apparatuses:
a first control process that performs control so that the first backup data and the second backup data are stored in the nonvolatile memory at each of the plurality of storage control apparatuses; and
a second control process that performs control to move dirty data between the respective cache regions of the plurality of storage control apparatuses to make amounts of the dirty data in the respective cache regions of the plurality of storage control apparatuses substantially equal and to store dirty data, which is present in the respective cache regions of the plurality of storage control apparatuses after movement of the dirty data, into the respective nonvolatile memories of the plurality of storage control apparatuses.

3. The storage system according to claim 2,
wherein the processor of the master apparatus selectively executes the first control process and the second control process based on whether the ratio has been decided so that the differences in the total amount between the plurality of storage control apparatuses are within a threshold range based on an average amount of dirty data in the respective cache regions of the plurality of storage control apparatuses.

4. The storage system according to claim 1,
wherein when supplying of power from the power supply is recommenced, the processor of each of the plurality of storage control apparatuses reads out the dirty data stored in the nonvolatile memory, executes a recovery process for writing back the read out dirty data into a predetermined storage apparatus, and, when the recovery process is complete and recharging of the battery with power from the power supply is complete, commences write control according to a write back technique into the predetermined storage apparatus using the cache region.

5. A management apparatus comprising a first processor that manages a plurality of storage control apparatuses that are placed in a cyclic arrangement and operate on power supplied from a power supply,
wherein the plurality of storage control apparatuses each include:
a volatile memory including a cache region and a mirror cache region;
a nonvolatile memory;
a second processor that mirrors data stored in the cache region to the mirror cache region of another storage control apparatus that is adjacent in a predetermined direction in the cyclic arrangement of the plurality of storage control apparatuses; and
a battery that supplies power for storing data from the volatile memory into the nonvolatile memory when there is a power failure for the power supply,
wherein the first processor:
classifies, at each of the storage control apparatuses when there is a power failure for the power supply, dirty data stored in the cache region into first data and second data, and designates the first data stored in the cache region as first backup data and designates mirror data of the second data, which is stored in the mirror cache region of said another storage control apparatus adjacent in the predetermined direction, as second backup data, wherein classification of the dirty data includes deciding a ratio of data amounts of the first data and the second data for each of the plurality of storage control apparatuses so that differences between the storage control apparatuses in a total amount of the first backup data designated in the cache region and the second backup data designated in the mirror cache region are within a predetermined range; and
controls the plurality of storage control apparatuses so that each of the plurality of storage control apparatuses stores the first backup data and the second backup data in the nonvolatile memory.

6. The management apparatus according to claim 5,
wherein when there is a power failure for the power supply, the first processor selectively executes, based on the total amount at each of the plurality of storage control apparatuses:
a first control process that performs control so that the first backup data and the second backup data are stored in the nonvolatile memory at each of the plurality of storage control apparatuses; and
a second control process that performs control to move dirty data between the respective cache regions of the plurality of storage control apparatuses to make amounts of the dirty data in the respective cache regions of the plurality of storage control apparatuses substantially equal and to store dirty data, which is present in the respective cache regions of the plurality of storage control apparatuses after movement of the dirty data, into the respective nonvolatile memories of the plurality of storage control apparatuses.

7. The management apparatus according to claim 6,
wherein the first processor selectively executes the first control process and the second control process based on whether the ratio has been decided so that the differences in the total amount between the plurality of storage control apparatuses are within a threshold range based on an average amount of dirty data in the respective cache regions of the plurality of storage control apparatuses.
